(19) United States
(12) Patent Application Publication
(10) Pub. No.: US 2016/0169111 A1
(43) Pub. Date: Jun. 16, 2016

(54) PIVOTING STOWABLE SPRAYBAR

(71) Applicant: Rolls-Royce North American Technologies, Inc., Indianapolis, IN (US)

(72) Inventors: David L. Sutterfield, Greenwood, IN (US); William J. Dionne, Windsor, CT (US)

(73) Assignee: Rolls-Royce North American Technologies, Inc., Indianapolis, IN (US)

(21) Appl. No.: 14/968,320

(22) Filed: Dec. 14, 2015

Related U.S. Application Data
(60) Provisional application No. 62/091,841, filed on Dec. 15, 2014.

(51) Int. Cl. F02C 7/22

(52) U.S. Cl. CPC F02C 7/222

(57) ABSTRACT

An exemplary fuel spray bar system can include a conduit, which is pivotally attached to an engine frame and configured to deliver fuel from a fuel line to an engine flow path. The system further includes a drive mechanism, which is configured to move the conduit between a stowed position and a deployed position.

### CROSS-REFERENCE TO RELATED APPLICATIONS

This application claims priority to U.S. Provisional Patent Application No. 62/091,841 filed Dec. 15, 2014, the contents of which is hereby incorporated in its entirety.

### FIELD OF TECHNOLOGY

The present disclosure relates to gas turbine engines and more particularly, but not exclusively, to a pivoting stowable spray bar configured to deliver fuel to an engine flow path of an exhaust nozzle during afterburner operation and further configured to be stowed in a position spaced apart from the engine flow path, thus preventing aerodynamic losses corresponding with the spray bar obstructing the engine flow path and further avoiding an increased overall nozzle diameter.

### BACKGROUND

Aircraft manufacturers continuously investigate improvements to the efficiency and performance of engine components. For instance, a jet engine afterburner can include a series of fixed spray bars positioned within the exhaust nozzle and permanently suspended in an engine flow path of the gas turbine engine. The stationary configuration of the spray bars obstructs the engine flow path and the overall diameter of the nozzle may be increased to compensate for the corresponding aerodynamic losses. However, the increased overall diameter may be larger than required for most operating conditions, thus reducing the efficiency of the engine.

It would therefore be helpful to provide a fuel spray bar system that can reduce aerodynamic losses and improve the performance and efficiency of a gas turbine engine.

### BRIEF DESCRIPTION OF THE DRAWINGS

While the claims are not limited to a specific illustration, an appreciation of the various aspects is best gained through a discussion of various examples thereof. Referring now to the drawings, exemplary illustrations are shown in detail. Although the drawings represent the illustrations, the drawings are not necessarily to scale and certain features may be exaggerated to better illustrate and explain an innovative aspect of an example. Further, the exemplary illustrations described herein are not intended to be exhaustive or otherwise limiting or restricted to the precise form and configuration shown in the drawings and disclosed in the following detailed description. Exemplary illustrations are described in detail by referring to the drawings as follows:

FIG. 1 schematically illustrates some aspects of one non-limiting example of a gas turbine engine including an exhaust nozzle that has a fuel spray bar system configured to deliver fuel to an engine flow path and be stowed in a position spaced apart from the engine flow path, in accordance with one non-limiting exemplary embodiment of the present disclosure;

FIG. 2 is an enlarged view of one portion of the fuel spray bar system of FIG. 1, showing the system holding a spray bar in a stowed position that is spaced apart from an engine flow path;

FIG. 3 is enlarged view of one portion of the fuel spray bar system of FIG. 1, showing the system moving a spray bar to a deployed position within the engine flow path;

FIG. 4 is another enlarged cutaway view of the fuel spray bar system of FIG. 1, showing the system holding a spray bar in a stowed position that is spaced apart from an engine flow path;

FIG. 5A is an elevation view of one portion of the system of FIG. 1, showing the system having a drive mechanism including an outer drive ring and an inner drive ring configured to hold the spray bar in a stowed position;

FIG. 5B is an elevation view of one portion of the system of FIG. 5A, showing the outer drive ring configured to rotate in a circumferential direction about a longitudinal axis and the inner drive ring configured to move along the longitudinal axis in response to the rotation of the outer drive ring, thus pivoting the spray bar from the stowed position to the deployed position;

and

FIG. 6 is a flow chart of a method for operating the fuel spray bar system of FIG. 1.

### DETAILED DESCRIPTION

An exemplary fuel spray bar system (hereinafter “system”) and an exemplary control scheme for the same are described herein and are shown in the attached drawings. The system can include a conduit, which is pivotally attached to an engine frame and configured to deliver fuel from a fuel line to an engine flow path. In one non-limiting exemplary embodiment as described herein, the system can be integrated within an exhaust nozzle of gas turbine engine, so as to selectively supply fuel to the operating fluid of the gas turbine engine. The fuel may combust in the exhaust nozzle, thus providing additional thrust during afterburner operation. However, the system can be integrated within other portions of the gas turbine engine or various other suitable engines. Moreover, the system can include a drive mechanism, which is configured to move the conduit between a stowed position and a deployed position. The conduit in the deployed position is disposed within the engine flow path and can deliver fuel into the engine flow path and increase the thrust of the engine. The conduit in the stowed position is spaced apart from the engine flow path. One exemplary benefit of this system is that the conduit may be moved to the stowed position when, for example, fuel is not delivered to the engine flow path, thus preventing the conduit from obstructing the engine flow path. One non-limiting exemplary benefit of the drive mechanism is that it can have a compact configuration that can be packaged between an outer casing and an outer liner of an exhaust nozzle without requiring an overall diameter of the exhaust nozzle that would be larger than required over most operating conditions, thus improving the efficiency of the engine.

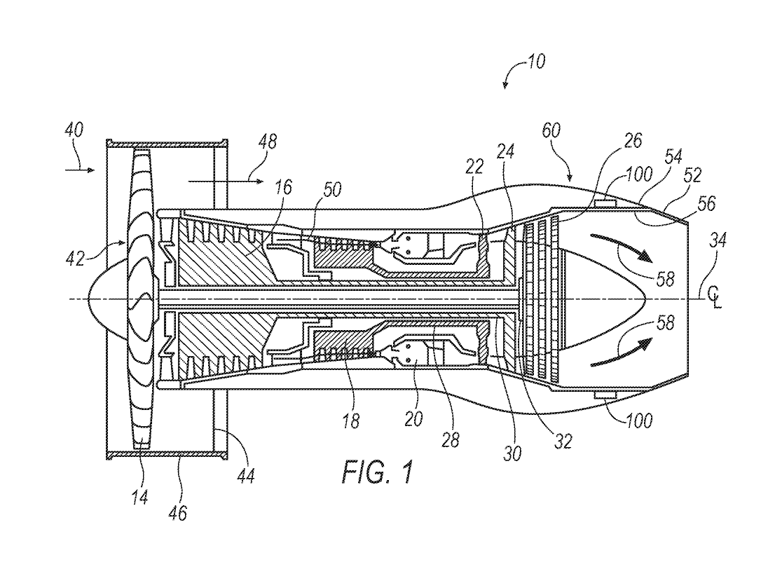

FIG. 1 illustrates a gas turbine engine 10, which includes a low pressure compressor 14 (“LP compressor”), intermediate pressure compressor 16 (“IP compressor”), a high pressure compressor 18 (“HP compressor”), a combustor 20, a high pressure turbine 22 (“HP turbine”), an intermediate pressure turbine 24 (“IP turbine”) and low pressure turbine 26 (“LP turbine”). The HP compressor 18, the IP compressor 16 and the LP compressor 14 are connected to a respective one of an HP shaft 28, an IP shaft 30 and an LP shaft 32, which in turn are connected to a respective one of the HP turbine 22, the IP turbine 24 and the LP turbine 26. The shafts extend axially and are parallel to a longitudinal center line axis 34. While FIG. 1 illustrates a three shaft engine, it will be appreciated that other embodiments can have configurations including more or less than three shafts. During general operation of the engine 10, ambient air 40 enters the LP compressor 14 and is directed across a fan rotor 42 in an annular duct 44, which in part is circumscribed by fan case 46. The bypass airflow 48 provides a fraction of engine thrust while the primary gas stream 50 is directed to the combustor 20 and the turbines 22, 24, 26, and then exhausted through a nozzle 52 generating thrust. The nozzle 52 can have an outer casing 54 and an outer liner 56, which is disposed concentrically within the outer casing 54. The outer liner 56 surrounds or defines an engine flow path 58 configured to pass the operating fluid of the engine 10. Moreover, the nozzle 52 includes one non-limiting example of a fuel spray bar system 100, which has a drive mechanism spaced apart from the engine flow path 58 and disposed between the outer casing 54 and the outer liner 56. The system 100 further includes a conduit configured to deliver fuel to the operating fluid of the engine 10 and provide additional thrust during afterburner operation.

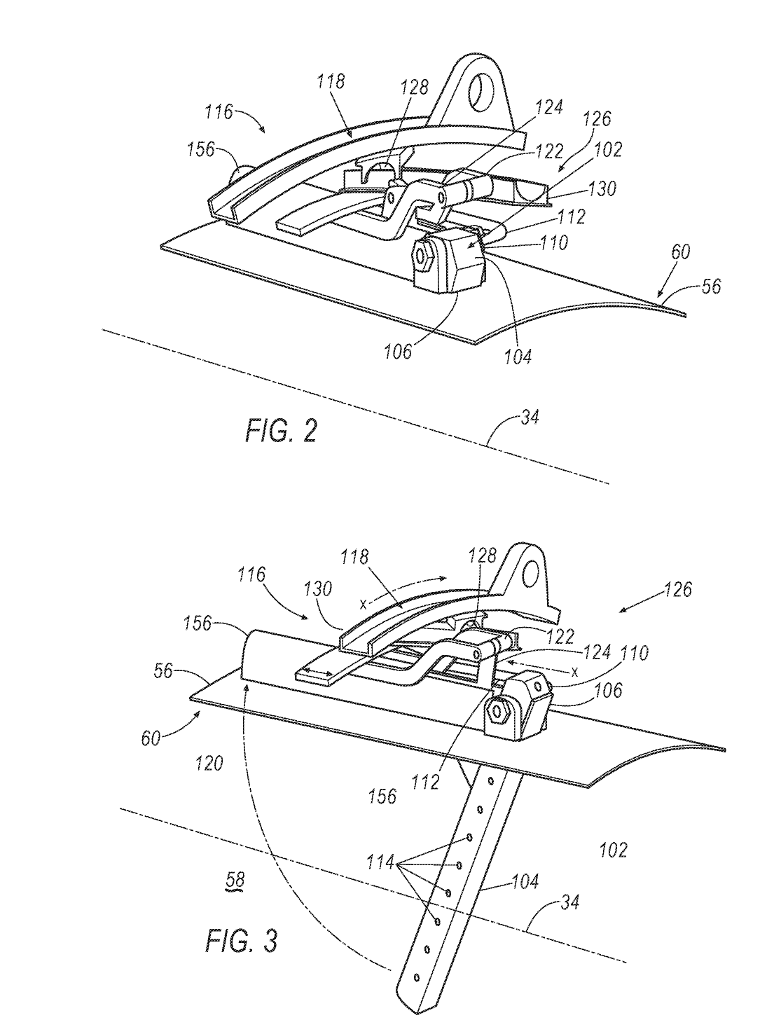

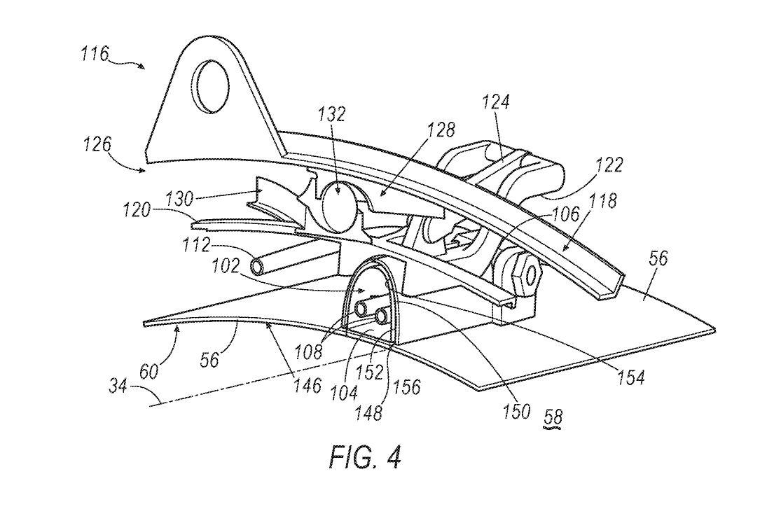

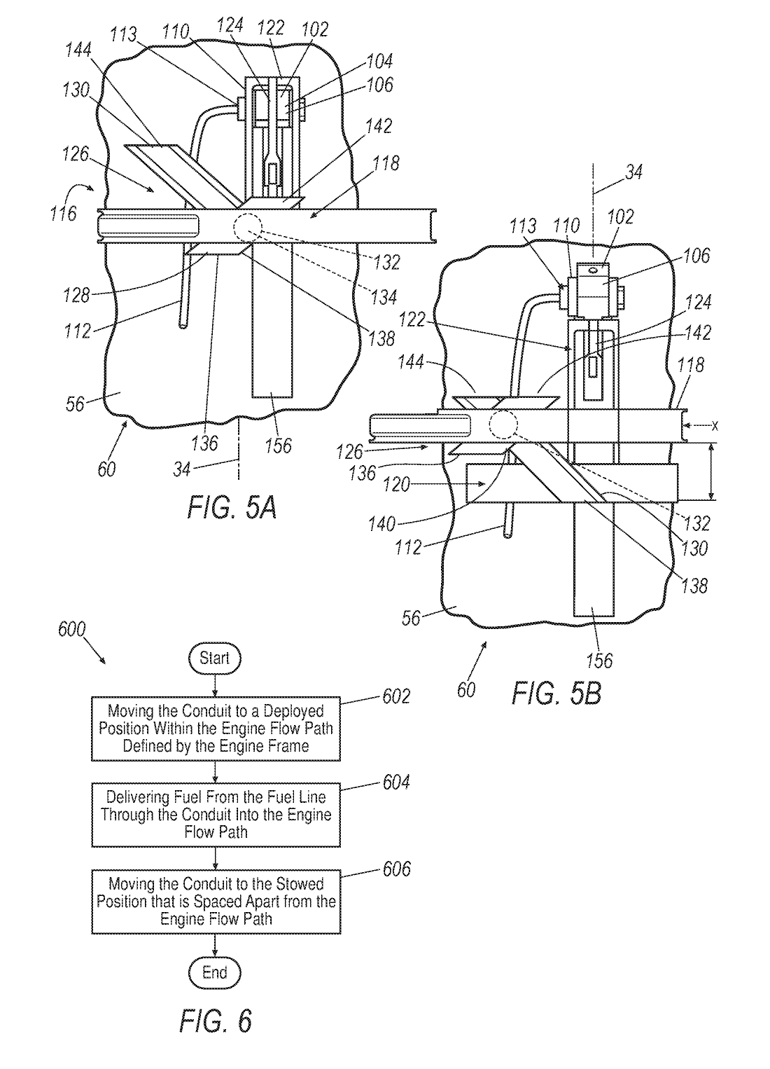

Referring now to FIGS. 2 through 4, there is illustrated an enlarged view of one portion of the fuel spray bar system 100 of FIG. 1, which includes a conduit 102 pivotally attached to an engine frame 60 and configured to move between a stowed position (FIGS. 2 and 4) and a deployed position (FIG. 3). As best shown in FIG. 4, the exemplary conduit 102 can include a housing 104 having an end portion 106, which is pivotally attached to the outer liner 56 of the frame 60. However, the housing 104 may be attached to other portions of the system or engine. Moreover, the conduit 102 can further include one or more pipes 108 or other suitable passages contained within the housing 104. Referring now to FIGS. 5A and 5B, the pipes 108 have an inlet 110, which fluidly communicates with a fuel line 112 and is configured to receive fuel from the fuel line 112. In this example, the system 100 further includes a fuel fitting 113 configured to sealingly and pivotally attach the inlet 110 of the pipes 108 to the fuel line 112. The pipes 108 further include a plurality of atomizing apertures 114 (FIG. 3) fluidly communicating with the inlet 110, such that the conduit 102 in the deployed position is configured to deliver fuel from the inlet 110 through the apertures 114 and into the engine flow path 58. For instance, the conduit 102 in the deployed position (FIG. 3) is disposed within the engine flow path 58 and can thus efficiently deliver fuel into the engine flow path 58 of the exhaust nozzle 52 and produce additional thrust during afterburner operation. The conduit 102 may be moved to the stowed position (FIGS. 2 and 4), which is located radially outward from the outer liner 56 and radially inward from the outer casing 54, and thus the conduit 102 may be spaced apart from the engine flow path 58 so as not to obstruct the engine flow path 58 when, for example, afterburner is not required.

Referring to FIGS. 2 through 5B, the system 100 further includes a drive mechanism 116 configured to move the conduit 102 between the stowed and the deployed positions. This exemplary configuration is compact and is disposed between the outer liner 56 and the outer casing 54 of the nozzle 52. More specifically, the exemplary drive mechanism 116 includes an outer drive ring 118, which is configured to rotate about the longitudinal axis 34 of the engine frame 60. In addition, the drive mechanism 116 further includes an inner drive ring 120, which is configured to move along the longitudinal axis 34 of the engine frame 60. The exemplary inner drive ring 120 includes a clevis 122 pivotally attached to a link 124 that is in turn pivotally attached to the conduit 102, thus moving the conduit 102 between stowed and deployed positions in response to the inner drive ring 120 moving along the longitudinal axis 34. However, the inner drive ring can instead include a link pivotally attached to a clevis that is in turn pivotally attached to the conduit. Various suitable linkage assemblies or pivoting or sliding attachments between the inner drive ring and the conduit may be utilized. As discussed in more detail below and with reference to the orientation shown in FIG. 5B, the outer drive ring 118 can rotate about the longitudinal axis toward the left of the FIG. 5B, and a roller bearing assembly attached to the outer and inner drive rings causes the inner drive ring 120 to move linearly along the longitudinal axis toward the bottom of the FIG. 5B, which in turn causes the conduit to move toward the deployed position into the engine flow path. The reverse rotation of the outer drive ring returns the conduit to the stowed position.

The drive mechanism 116 further includes a roller bearing assembly 126, which is configured to convert rotational motion of the outer drive ring 118 into linear movement of the inner drive ring 120, which in turn moves the conduit 102 between deployed and stowed positions. In particular, the roller bearing assembly 126 includes one or more outer channels 128 attached to the outer drive ring 118 and one or more corresponding inner channels 130 attached to the inner drive ring 120. Each one of the inner channels 130 is disposed in a non-parallel position with respect to the corresponding outer channel 128, such that a portion of the inner channel 130 traverses or overlaps a corresponding portion of the outer channel 128. As shown in FIGS. 4 and 5, a ball bearing 132 is held between each pair of corresponding inner and outer channels 128, 130. With particular attention to FIG. 5, when the conduit 102 is held in the stowed position, the ball bearing 132 may be held in corresponding overlapping portions 134 of the inner and outer channels 128, 130 adjacent to respective aft ends 136, 138 of the channels 128, 130. When the conduit 102 is moved to the deployed position, the ball bearing 132 may be held in corresponding overlapping portions 140 of the outer and inner channels 128, 130 adjacent to respective forward ends 142, 144 of the channels 128, 130. Thus, the roller bearing assembly 126 is configured to move the inner drive ring 120 along the longitudinal axis 34 thereby moving the conduit 102 between stowed and deployed positions, in response to the outer drive ring 118 rotating about the longitudinal axis 34. It is contemplated that the drive mechanism can instead include various other suitable bearing assemblies that convert the rotational force of the outer drive ring into the longitudinal force of the inner drive ring. In addition, the drive mechanism may various suitable drive components other than the outer and inner drive rings.

Referring to FIG. 4, the outer liner 56 has a wall 146 defining the engine flow path 58, and the wall 146 has a hole 148 formed therein and configured to permit the conduit 102 to move between the stowed and deployed positions. The system 100 further includes a fairing 150 that is attached to the outer liner 56, and defines an opening 152 that is aligned with a hole 148 in the outer liner 56, such that the opening 152 communicates with the engine flow path 58. The fairing 150 further defines a recess 154 that communicates with the opening 152 and is configured to receive the conduit 102 disposed in the stowed position. Thus, the conduit 102 in the stowed position may be received within the fairing 150 and disposed radially outward from the outer liner 56, such that the conduit 102 is spaced apart from the engine flow path 58 and does not obstruct the same.

The system 100 can further include a heat shield 156, which is attached to the fairing 150, and configured to decrease the amount of heat transferred from the engine flow path 58 to any portion of the drive mechanism 116 or other components disposed between the outer liner 56 and the outer casing 54. In one example, the drive mechanism 116 can be attached to the conduit 102 on a side of the fairing 150 opposite to the opening 152 in the fairing 150.

Referring now to FIG. 6, there is illustrated a flow chart of method 600 for operating the system 100 of FIGS. 2-5. At step 602, the conduit 102 is moved to the deployed position within the engine flow path 58, which is defined by the engine frame 60. This step may be accomplished by rotating the outer drive ring 118 in a first rotational direction about the longitudinal axis 34, which moves the inner drive ring 120 in a first longitudinal direction along the longitudinal axis 34, which in turn moves the conduit 102 from the stowed position to the deployed position.

At step 604, fuel is delivered from the fuel line 112 through the conduit 102 into the engine flow path 58 when the conduit 102 is disposed in the deployed position, so as to produce additional thrust in an afterburner condition.

At step 606, fuel supply through the fuel line is stopped, and the conduit 102 is moved to the stowed position spaced apart from the engine flow path 58. This step may be accomplished by rotating the outer drive ring 118 in a second rotational direction opposite to the first rotational direction, which moves the inner drive ring 120 in a second longitudinal direction opposite to the first longitudinal direction, which in turn moves the conduit 102 from the deployed position to the stowed position. Thus, the conduit 102 does not obstruct the engine flow path and produce any corresponding aerodynamic losses that would adversely affect efficiency of the engine.

All terms used in the claims are intended to be given their broadest reasonable constructions and their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary.

What is claimed as new and desired to be protected by Letters Patent of the United States is:

1. A fuel spray bar system, comprising:
a conduit pivotally attached to an engine frame and configured to deliver fuel from a fuel line to an engine flow path; and
a drive mechanism configured to move the conduit between a stowed position and a deployed position;
wherein the conduit in the deployed position is disposed within the engine flow path and the conduit in the stowed position is spaced apart from the engine flow path.

2. The fuel spray bar system of claim 1, wherein the conduit includes an inlet fluidly communicating with the fuel line.

3. The fuel spray bar system of claim 2, wherein the conduit includes a plurality of atomizing apertures fluidly communicating with the inlet, such that the conduit in the deployed position is configured to deliver fuel from the inlet through the apertures and into the engine flow path.

4. The fuel spray bar system of claim 1, further comprising a fairing that defines an opening communicating with the engine flow path, and the fairing further defines a recess that communicates with the opening and is configured to receive the conduit in the stowed position.

5. The fuel spray bar system of claim 4, wherein the drive mechanism is attached to the conduit on a side of the fairing opposite to the opening in the fairing.

6. The fuel spray bar system of claim 1, wherein drive mechanism comprises:
an outer drive ring configured to rotate about a longitudinal axis of the engine frame;
an inner drive ring disposed concentrically within the outer drive ring and configured to move along the longitudinal axis of the engine frame;
a roller bearing assembly attached to the outer and inner drive rings, and the roller bearing assembly is configured to move the inner drive ring along the longitudinal axis in response to the outer drive ring rotating about the longitudinal axis;
wherein the conduit is attached to the inner drive ring, and the inner drive ring is configured to move the conduit between the stowed and deployed positions in response to the inner drive ring moving along the longitudinal axis. The fuel spray bar system of claim 6, wherein the roller bearing assembly comprises:
an outer channel attached to the outer drive ring;
an inner channel attached to the inner drive ring, and the inner channel is disposed in a non-parallel position with respect to the outer channel, such that a portion of the inner channel overlaps a corresponding portion of the outer channel; and
a ball bearing held between corresponding portions of the inner and outer channels, and the ball bearing is configured to move the inner drive ring along the longitudinal axis in response to the outer drive ring rotating about the longitudinal axis.

8. The fuel spray bar system of claim 6, wherein one of the inner drive ring and the conduit includes a clevis and the other of the inner drive ring and the conduit includes a linkage pivotally attached to the clevis.

9. The fuel spray bar system of claim 1, further comprising a fuel fitting configured to pivotally attach the fuel line to the conduit.

10. An exhaust nozzle for a gas turbine engine, the nozzle comprising:
an engine frame including an outer casing and an outer liner disposed concentrically within the outer casing, and the outer liner surrounds an engine flow path; and
a fuel spray bar system having a conduit that is pivotally attached to the outer liner of the engine frame, and the system is configured to deliver fuel from a fuel line to the engine flow path; and
a drive mechanism configured to move the conduit between a stowed position and a deployed position;
wherein the conduit in the deployed position is disposed within the engine flow path and the conduit in the stowed position is spaced apart from the engine flow path.

11. The exhaust nozzle of claim 10, wherein the conduit in the stowed position is disposed radially outward from the outer liner and radially inward from the outer casing.

12. The exhaust nozzle of claim 10, wherein the outer liner has a wall defining the engine flow path and the wall has a hole that is formed therein and configured to permit the conduit to move between the stowed and deployed positions.

13. The exhaust nozzle of claim 12, further comprising a fairing that is attached to the outer liner and defines an opening that is aligned with the hole in the outer liner such that the opening communicates with the engine flow path, and the fairing further defines a recess that communicates with the opening and is configured to receive the conduit in the stowed position.

14. The exhaust nozzle of claim 10, wherein the drive mechanism is spaced apart from the engine flow path and disposed between the outer casing and the outer liner.

15. The exhaust nozzle of claim 10, wherein drive mechanism comprises:
an outer drive ring configured to rotate about a longitudinal axis of the engine frame;
an inner drive ring disposed concentrically within the outer drive ring and configured to move along the longitudinal axis of the engine frame;
a roller bearing assembly attached to the outer and inner drive rings, and the roller bearing assembly is configured to move the inner drive ring along the longitudinal axis in response to the outer drive ring rotating about the longitudinal axis;
wherein the conduit is attached to the inner drive ring, and the inner drive ring is configured to move the conduit between the stowed and deployed positions in response to the inner drive ring moving along the longitudinal axis.

16. The exhaust nozzle of claim 15, wherein the roller bearing assembly comprises:
an outer channel attached to the outer drive ring;
an inner channel attached to the inner drive ring, and the inner channel is disposed in a non-parallel position with respect to the outer channel, such that a portion of the inner channel overlaps a corresponding portion of the outer channel; and
a ball bearing held between corresponding portions of the inner and outer channels, and the ball bearing is configured to move the inner drive ring along the longitudinal axis in response to the outer drive ring rotating about the longitudinal axis.

17. The exhaust nozzle of claim 15, wherein one of the inner drive ring and the conduit includes a clevis and the other of the inner drive ring and the conduit includes a linkage pivotally attached to the clevis.

18. The exhaust nozzle of claim 10, further comprising a fuel fitting configured to pivotally attach the fuel line to the conduit.

19. A method for operating a fuel spray bar system, the method comprising:
moving a conduit to a stowed position that is spaced apart from an engine flow path defined by an engine frame;
moving the conduit to a deployed position within the engine flow path; and
delivering fuel from a fuel line through the conduit and into the flow path when the conduit is disposed in the deployed position.

20. The method of claim 19, further comprising:
rotating an outer drive ring about a longitudinal axis of the engine frame;
moving an inner drive ring along the longitudinal axis of the engine frame in response to the outer drive ring rotating about the longitudinal axis, and the inner drive ring is disposed concentrically within the outer drive ring; and
moving the conduit between the stowed and deployed positions in response to the inner drive ring moving along the longitudinal axis.
